(19) United States
(12) Patent Application Publication
(10) Pub. No.: US 2026/0202367 A1
(43) Pub. Date: Jul. 16, 2026

(54) DYNAMIC MONITORING DEVICE AND METHOD FOR SCOUR INTERFACES OF OFFSHORE WIND TURBINE PILE FOUNDATIONS

(71) Applicant: Nanjing University, Nanjing (CN)

(72) Inventors: Daoyuan TAN, Nanjing (CN); Honghu ZHU, Nanjing (CN); Bin SHI, Nanjing (CN); Wenbin SUO, Nanjing (CN)

(21) Appl. No.: 19/444,873

(22) Filed: Jan. 9, 2026

(30) Foreign Application Priority Data
Jan. 16, 2025 (CN) 202510067537.8

(51) Int. Cl. G01N 25/18; F03D 17/00; H05B 3/56

(52) U.S. Cl. CPC G01N 25/18; F03D 17/027; H05B 3/56; F05B 2260/83

(57) ABSTRACT

The present application discloses a dynamic monitoring device and method for the scour interfaces of offshore wind turbine pile foundations. The monitoring device includes an internal heating temperature-measuring optical cable, a heating unit, an optical fiber temperature measurement unit, a monitoring error correction unit, a thermal conductivity calculation unit, and a scour area detection unit. During monitoring, the optical fiber temperature measurement unit transmits the collected temperature data during heating to the monitoring error correction unit. After the monitoring error correction unit realizes the error correction of the monitoring data by adopting a hybrid attention neural network algorithm, it transmits the data to the thermal conductivity calculation unit. The thermal conductivity calculation unit calculates the thermal conductivity of each medium along the length direction of the pile foundation by using the corrected temperature data and transmits the results to the scour area detection unit.

### CROSS-REFERENCE TO RELATED APPLICATIONS

The present application claims priority to Chinese Patent Application No. 202510067537.8, filed on Jan. 16, 2025, the entire disclosure of both are incorporated herein by reference.

### TECHNICAL FIELD

The present application relates to the technical field of scour monitoring for offshore wind turbine pile foundations, in particular to a dynamic monitoring device and method for scour interfaces of offshore wind turbine pile foundations.

### BACKGROUND

Offshore wind turbine pile foundations are widely used in offshore engineering fields such as offshore platforms, wharves, cross-sea bridges, and offshore wind power. They are one of the important engineering structural forms in offshore engineering. However, the seabed in offshore areas is mostly composed of underconsolidated loose sedimentary soils such as sludge, silty sand, or fine sand, which will make the seabed around the pile foundations prone to scouring and erosion under the action of waves and ocean currents. Scouring not only weakens the bearing capacity of the soil around the pile foundations but may also lead to exposure, inclination, or even instability of the pile foundations, seriously threatening the long-term safety of offshore engineering facilities. Therefore, to ensure the safe operation of offshore engineering facilities, long-term and effective monitoring of the scouring status around offshore wind turbine pile foundations is of great significance.

There are various types of underwater pile foundation scour monitoring technologies. Currently commonly used monitoring technologies include sonar, sliding magnetic rings, ground-penetrating radar (GPR), and fiber Bragg grating (FBG) sensors.

Sonar technology measures the shape and depth of scouring pits on the seabed around pile foundations by emitting sound waves and receiving their reflected waves. When sound waves encounter interfaces of medium with different densities (such as the boundary between water and the seabed), they will reflect. Detailed information about the seabed can be obtained by measuring the return time and intensity of the sound waves. However, the resolution of sonar is limited by the wavelength of sound waves. In complex marine environments, multipath propagation may cause data distortion. In addition, this technology has poor real-time performance and is difficult to provide continuous dynamic scour monitoring.

The sliding magnetic ring monitoring technology is based on the principle of electromagnetic induction. It real-time monitors the speed and direction of water flow by sensing changes in the electromagnetic field in the water flow, thereby indirectly inferring the movement of soil. This method is suitable for monitoring soil movement during the scouring process. However, sliding magnetic rings are very sensitive to soil types and water flow speeds, which may easily lead to measurement errors. In addition, installation and maintenance are relatively complex, requiring ensuring the reliability and stability of the equipment underwater.

The working principle of ground-penetrating radar (GPR) is similar to that of sonar. It emits high-frequency electromagnetic waves to the seabed and obtains underground structural information using reflected echoes, and can provide high-resolution images and is suitable for various types of marine sediments. However, in seawater and saturated soil, the penetration capacity of GPR is limited, resulting in severe signal attenuation. In addition, weather and seasonal changes can also affect the detection effect, leading to a decrease in data reliability.

Fiber Bragg grating (FBG) sensors utilize the propagation characteristics of light in optical fibers to obtain strain or temperature information along the optical fiber by measuring changes in the wavelength of the reflected light from the Bragg grating. This technology has high sensitivity and is resistant to electromagnetic interference, but its monitoring is point-based and cannot achieve distributed monitoring.

In summary, although existing technologies can monitor the scouring status of offshore wind turbine pile foundations to a certain extent, none of them can achieve real-time and fully distributed monitoring effects. Therefore, how to realize fully distributed real-time monitoring of offshore wind turbine pile foundations has become an urgent technical problem to be solved.

### SUMMARY

Purpose of the present application: aiming at the technical problems existing in the prior art, the present application proposes a dynamic monitoring device and method for scour interfaces of offshore wind turbine pile foundations. In the present application, the monitoring error correction unit corrects the error of temperature data by using a hybrid attention neural network algorithm to obtain the corrected temperature change rate; the thermal conductivity calculation unit calculates the thermal conductivity of each medium along a length direction of the pile foundation according to the corrected temperature change rate; the scour area detection unit obtains a thermal conductivity gradient curve based on the thermal conductivity, determines the scour area according to the thermal conductivity gradient curve, and judges the scour state of the pile foundation, thereby improving the accuracy of scour detection.

Technical Solution: the dynamic monitoring device for the scour interfaces of offshore wind turbine pile foundations of the present application includes an internal heating temperature-measuring optical cable, a heating unit, an optical fiber temperature measurement unit, a monitoring error correction unit, a thermal conductivity calculation unit, and a scour area detection unit. The internal heating temperature-measuring optical cable is composed of an internal heating resistance wire and a temperature-sensing optical fiber; the internal heating temperature-measuring optical cable is fixed on the offshore wind turbine pile foundation; the internal heating resistance wire is connected to the heating unit, and the temperature-sensing optical fiber is connected to the optical fiber temperature measurement unit. After collecting the temperature data of the internal heating temperature-measuring optical cable during the heating process, the optical fiber temperature measurement unit transmits the data to the monitoring error correction unit.

The dynamic monitoring method for the scour interfaces of offshore wind turbine pile foundations of the present application includes:
(1) After the fabrication of the offshore wind turbine pile foundation is completed, fixing the internal heating temperature-measuring optical cable on the offshore wind turbine pile foundation; after a construction of the offshore wind turbine pile foundation is completed, connecting internal heating resistance wires in the internal heating temperature-measuring optical cable to the heating unit, and performing waterproof protection; connecting the temperature-sensing optical fibers in the internal heating temperature-measuring optical cable to the optical fiber temperature measurement unit through optical fiber jumpers;
(2) powering on the heating unit, and the optical fiber temperature measurement unit collecting the temperature data of the temperature-measuring optical cable during the heating process;
(3) the optical fiber temperature measurement unit transmitting the temperature data to the monitoring error correction unit; the monitoring error correction unit using a hybrid attention neural network algorithm to correct an error of the temperature data, and transmitting a corrected temperature change rate to the thermal conductivity calculation unit; the thermal conductivity calculation unit calculating a thermal conductivity along a length direction of the pile foundation according to the corrected temperature change rate, comprising:

(3.1) measuring and calculating a temperature change rate K_{T}_{ᵢ} of medium i between the heating times t₁ and t₂ by the optical fiber temperature measurement unit:

$${K}_{{T}_{i}} = \frac{{T}_{i} ( {t}_{2} ) - {T}_{i} ( {t}_{1} )}{{t}_{2} - {t}_{1}} ;$$

wherein the medium i comprises seawater, seabed sediments, and an interface between seawater and seabed sediments; T is temperature corresponding to two time points; Tᵢ(t₁) is a temperature corresponding to a line source in medium i measured by the optical fiber temperature measurement unit at time t₁; Tᵢ(t₂) is a temperature corresponding to a line source in medium i measured by the optical fiber temperature measurement unit at time t₂;

measuring an accurate value K_{T}_{ᵢ} of the temperature change rate of the medium i with high-precision temperature measurement device a within a same heating time period in a laboratory:

$${K}_{{T}_{i}}^{′} = \frac{{T}_{i}^{′} ( {t}_{2} ) - {T}_{i}^{′} ( {t}_{1} )}{{t}_{2} - {t}_{1}} ;$$

taking the obtained K_{T}_{ᵢ} as a target value for supervising a neural network; Tᵢ′(t₁) is the temperature corresponding to the line source in the medium i measured in the laboratory at time t₁; Tᵢ′(t₂) is the temperature corresponding to the line source in the medium i measured in the laboratory at time t₂;

obtaining a corrected temperature change rate K by using a following error correction formula:

$$K = {K}_{{T}_{i}} + Δ {K}_{{T}_{i}} ;$$

wherein ΔK_{T}_{ᵢ} is a temperature change rate error correction value predicted by the hybrid attention neural network;

the obtaining the temperature change rate error correction value ΔK_{T}_{ᵢ} by using the hybrid attention neural network algorithm is as follows: taking temperature change rates K_{T}_{ᵢ} of various medium and temperature change rates along a monitoring optical fiber as an input temperature change rate feature matrix X of a hybrid attention neural network, and extracting the temperature change rate feature map F_{c} of input features through a lightweight one-dimensional convolution layer:

$${F}_{c} = σ ( W * X + b ) ;$$

wherein W is a convolution kernel weight, b is a bias term, σ is an activation function, and X is the input temperature change rate feature matrix of the hybrid attention neural network;

(3.2) performing channel-wise max pooling and average pooling operations on the temperature change rate feature map F_{c} to obtain a max pooling result Fₘₐₓ and an average pooling result F_{avg}:

$${F}_{max} = max {F}_{c} ( X , c )$$

$${F}_{avg} = \frac{1}{C} {\sum }_{c = 1}^{C} {F}_{c} ( X , c ) ;$$

wherein c is a channel index, F_{c}(X,c) represents a feature value on the channel c after the input temperature change rate feature matrix X is processed by convolution and activation function; C is a total number of channels;

calculating a weight matrix A. of the temperature change rate feature map F_{c} based on a channel attention mechanism of global pooling:

$${A}_{c} = σ ( FC ( GAP ( {F}_{c} ) ) ) ;$$

wherein a Global Average Pooling (GAP) refers to calculating an average value of each channel of Fc to generate a feature vector of a specific length; a Fully Connected Layer (FC) refers to performing weighted learning on a feature vector to generate a weight of each channel;

adjusting each channel to obtain an enhanced temperature change rate feature map Fₑ:

$${F}_{e} = {A}_{c} ▯ {F}_{c} ;$$

wherein □ represents channel-wise dot multiplication;

(3.3) capturing a correlation between different positions of the enhanced temperature change rate feature map Fₑ by using a spatial attention mechanism, which is as follows:

generating a spatial weight Aₛ through multi-scale convolution:

$${A}_{s} = σ ( C o n v 2 D ( C o n c a t ( {F}_{max} , {F}_{avg} ) ) ) ;$$

wherein Concat refers to concatenating Fₘₐₓ and F_{avg} in a channel dimension to generate a joint temperature change rate feature map; Conv2D refers to learning a spatial attention weight from a concatenated joint temperature change rate feature map through two-dimensional convolution to extract significant features and global distribution features;

optimizing an enhanced temperature change rate feature map to obtain F_{final}:

$${F}_{final} = {A}_{s} ▯ {F}_{e} ;$$

correcting the optimized temperature change rate feature map F_{final} through quadratic weighted integration to obtain a temperature change rate error correction value ΔK_{T}_{ᵢ} of the medium i within the heating time:

$$Δ {K}_{{T}_{i}} = {\int }_{Ω} {F}_{final} ▯ {W}_{c o r r} d Ω ;$$

wherein Wcorr is a correction weight matrix, and Ω is a calculation area.

A loss function Lis used to optimize the correction weight matrix Wcorr and the temperature change rate error correction value K_{T}_{ᵢ} of the hybrid attention neural network; the loss function is:

$$L = \sum {w}_{i} ( ( {K}_{{T}_{i}} + Δ {K}_{{T}_{i}} ) - {K}_{{T}_{i}}^{′} ) + λ {‖ {W}_{c o r r} ‖}^{2} ;$$

wherein wᵢ is a weight for the medium i, λ is a parameter of regularization strength, Wcorr is the correction weight matrix, and λ∥W_{Corr}∥² is a regularization term; the loss function L updates the correction weight matrix Wcorr in each iteration, and outputs the corrected temperature change rate K when the loss function L reaches a minimum value.

wherein the thermal conductivity calculation unit calculates the thermal conductivity λₗ of the medium at a length l of the pile foundation according to the corrected temperature change rate:

$${λ}_{l} = \frac{q}{4 π K} ;$$

wherein λₗ is the thermal conductivity at the length l of the pile foundation, in unit W/(m·K), q is a heating power of the linear heat source, in unit W/m; K is a temperature change rate at the length/of the pile foundation corrected by the hybrid attention neural network, in unit K.

(4) the scour area detection unit calculates a thermal conductivity gradient gₗ along a length direction of the pile foundation according to a thermal conductivity of the medium, determines the scour area and detect the scour state according to the thermal conductivity gradient; the thermal conductivity gradient gₗ is:

$${g}_{l} = \frac{{λ}_{l} - {λ}_{x}}{X} ;$$

wherein λₗ is the thermal conductivity at the length l; λₓ is a thermal conductivity at an adjacent length x to the length l; X is a distance between two measuring points, and X is L/S, Lis a total length of a monitoring section, and S is a sampling resolution;

wherein the scour area detection unit detects a position difference of the thermal conductivity gradient mutation points between a thermal conductivity gradient curve and a reference curve when the pile foundation installation is completed, to obtain a length d of the scour area, a formula is: d=L₂−L₁;

wherein L₂ is a position of a mutation point in the thermal conductivity gradient curve; L, is a position of the mutation point in a reference curve;

wherein the length d of the scour area is compared with an original buried depth D of the foundation to obtain an instability coefficient F:

$$F = \frac{d}{D} ;$$

when the instability coefficient F is greater than a safety threshold f, a scour state of the pile foundation is unstable, there is a risk of collapse of the superstructure; when the instability coefficient F is less than the safety threshold f, the scour state of the pile foundation is stable, the superstructure is safe.

In one embodiment, in step (3.3), the optimized temperature change rate feature map F_{final} is corrected by quadratic weighted integration to obtain the temperature change rate error correction value K_{T}_{ᵢ} of the medium i within the heating time.

In one embodiment, in step (3.3), a loss function L is used to optimize the correction weight matrix Wcorr and the temperature change rate error correction value K_{T}_{ᵢ} of the hybrid attention neural network; the loss function is:

$$L = \sum {w}_{i} ( ( {K}_{{T}_{i}} + Δ {K}_{{T}_{i}} ) - {K}_{{T}_{i}}^{′} ) + λ {‖ {W}_{c o r r} ‖}^{2} ;$$

wherein wᵢ is a weight for the medium i, λ is a parameter of regularization strength, Wcorr is the correction weight matrix, and λ∥W_{corr}∥² is a regularization term; the loss function L updates the correction weight matrix Wcorr in each iteration, and outputs the corrected temperature change rate K when the loss function L reaches a minimum value.

In step (1), the internal heating temperature-measuring optical cable is fixed on the offshore wind turbine pile foundation by using waterproof adhesive.

In step (1), the internal heating temperature-measuring optical cable is protected by epoxy resin after being fixed.

In step (2), heating time and heating power of the heating unit are determined according to a designed buried depth of the pile foundation and an average depth of seawater.

In step (3), the heating power and heating duration are set according to the designed buried depth of the pile foundation and the local average seawater depth; the resolution S and sampling frequency of the optical fiber temperature measurement unit for data collection are determined based on the length of the pile foundation.

In step (4), during the monitoring error correction process, to improve the calculation accuracy of the temperature change rate, data calibrated in the laboratory is adopted to train the hybrid attention neural network.

Working Principle: the internal heating temperature-measuring optical cable of the present application is composed of an internal heating resistance wire and a temperature-sensing optical fiber. During the production of the offshore wind turbine pile foundation, the internal heating temperature-measuring optical cable is fixed on the pile foundation, and then the tail ends of the internal heating resistance wires of the internal heating temperature-measuring optical cable are welded together to form a circuit. The head ends of the internal heating resistance wires are connected to the heating unit; after the construction of the offshore wind turbine pile foundation is completed, the internal heating temperature-measuring optical cable is connected to the optical fiber temperature demodulator. The heating unit heats for a certain period of time according to the set power. After collecting the temperature data during this period, the optical fiber temperature demodulator transmits the data to the monitoring error correction unit. The monitoring error correction unit uses a hybrid attention neural network algorithm to correct the error of the temperature data to obtain the corrected temperature change rate. The thermal conductivity calculation unit calculates the thermal conductivity of each medium along the length direction of the pile foundation according to the corrected temperature change rate. The scour area detection unit obtains a thermal conductivity gradient curve based on the thermal conductivity, determines the scour area according to the thermal conductivity gradient curve, and judges the scour state of the pile foundation at the same time.

Beneficial Effects: compared with the related art, the present application has the following advantages:

(1) The monitoring method adopted in the present application realizes an efficient heating process through self-heating technology. During the heating process, the heat loss is extremely low, which ensures the effectiveness of heating and reduces the impact of the external environment on the heating effect. And since the present application combines optical frequency domain reflectometry (OFDR) technology, the temperature measurement accuracy to 0.01° C. is improved, the measurement accuracy of thermal conductivity is further enhanced, for providing reliable data support for determining the scour area, thereby improving the accuracy and reliability of scour detection.

(2) The present application uses a hybrid attention neural network algorithm to correct the monitoring data errors, further improving the accuracy of thermal conductivity calculation. This algorithm extracts key features from the monitoring data, eliminates noise and outliers, and ensures the reliability of the calculation results. The application of this technology provides strong support for the accurate detection of the scour area and further guarantees the stability and practicability of the monitoring system.

(3) The monitoring method of the present application relies on optical fiber sensing technology to realize. This technology has extremely strong anti-interference ability, especially in areas with complex electromagnetic environments, it will not be affected by electromagnetic interference, ensuring the stability of monitoring data. In addition, through the application of optical fiber sensors, all-weather foundation scour detection is realized. Even under severe weather conditions, the status of offshore wind turbine pile foundations is continuously detected. This all-weather real-time monitoring technology makes up for the shortcomings of traditional monitoring methods in terms of real-time performance and environmental adaptability, enabling more accurate dynamic feedback on the scour status of offshore wind turbine pile foundations.

(4) The sensor used in the present application has a high survival rate, can withstand harsh conditions in the marine environment, and ensures long-term stable operation. The design of the sensor enables distributed measurement along the length direction of the pile foundation, which can accurately capture the scour status at various positions of the pile foundation, no longer limited to the monitoring of a single measuring point. This distributed monitoring mode improves the comprehensiveness of data and facilitates understanding of the scour distribution around the pile foundation. The sensor is easy to be installed without complex construction steps, and is suitable for the monitoring needs of various offshore wind turbine pile foundations. Especially after the construction of the offshore wind turbine pile foundation is completed, the monitoring method of the present application can be put into use immediately for long-term monitoring of the local scour area of the pile foundation. This long-term monitoring capability not only provides continuous data support for the safe maintenance of offshore wind turbine pile foundations but also indirectly reduces subsequent engineering costs, having significant economic benefits.

### BRIEF DESCRIPTIONS OF THE DRAWINGS

FIG. 1 is a schematic structural diagram of a dynamic monitoring device for scour interfaces of offshore wind turbine pile foundations according to the present application.

FIG. 2 is a thermal conductivity curve along a length direction of the pile foundation in the present application.

FIG. 3 is a thermal conductivity gradient curve in the present application.

### DETAILED DESCRIPTIONS OF EMBODIMENTS

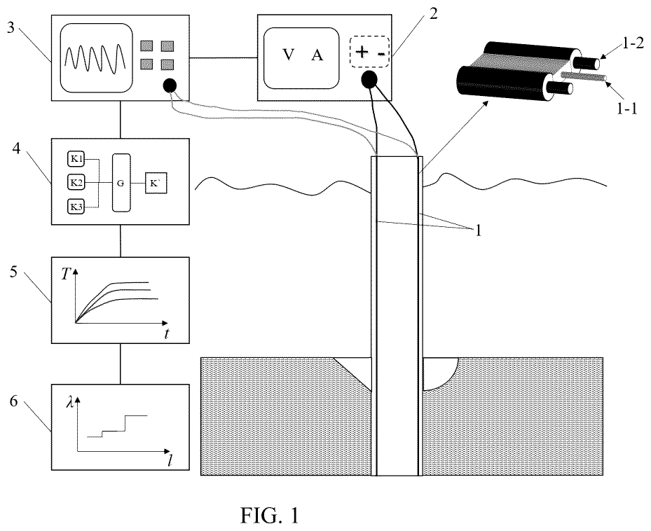

As shown in FIG. 1, the dynamic monitoring device for the scour interfaces of offshore wind turbine pile foundations of the present application includes an internal heating temperature-measuring optical cable 1, a heating unit 2, an optical fiber temperature measurement unit 3, a monitoring error correction unit 4, a thermal conductivity calculation unit 5, and a scour area detection unit 6. The internal heating temperature-measuring optical cable 1 is composed of two internal heating resistance wires 1-1 and one temperature-sensing optical fiber 1-2.

The internal heating temperature-measuring optical cable 1 is fixed on the offshore wind turbine pile foundation; in this embodiment, the internal heating temperature-measuring optical cable 1 is pasted on the surface of the offshore wind turbine pile foundation. The internal heating resistance wires 1-1 in the internal heating temperature-measuring optical cable 1 are connected to the heating unit 2, and the temperature-sensing optical fiber 1-2 is connected to the optical fiber temperature measurement unit 3; after collecting the temperature data of the internal heating temperature-measuring optical cable 1 during the heating process, the optical fiber temperature measurement unit 3 transmits the data to the monitoring error correction unit 4; after the monitoring error correction unit 4 corrects the error of the temperature data to obtain the temperature change rate, it transmits the temperature change rate to the thermal conductivity calculation unit 5; the thermal conductivity calculation unit 5 calculates the thermal conductivity of the medium along the length direction of the pile foundation and transmits it to the scour area detection unit 6; the scour area detection unit 6 obtains a thermal conductivity gradient curve according to the thermal conductivity, and then determines the scour area and detects the scour state.

The dynamic monitoring method for the scour interfaces of offshore wind turbine pile foundations of the present application includes:

(1) Pasting and fixing the internal heating temperature-measuring optical cable 1 on the offshore wind turbine pile foundation; welding the two internal heating resistance wires 1-1 in the internal heating temperature-measuring optical cable 1 located at the tail of the pile foundation together; connecting the internal heating resistance wires 1-1 in the internal heating temperature-measuring optical cable 1 located at the top of the pile foundation to the heating unit 2.

(2) After the construction of the pile foundation is completed, connecting the temperature-sensing optical fiber 1-2 to the optical fiber temperature measurement unit 3 through an optical fiber jumper; powering on the heating unit 2, and the optical fiber temperature measurement unit 3 collecting the temperature data along the length direction of the pile foundation during the heating period.

(3) Transmitting the temperature data collected by the optical fiber temperature measurement unit 3 to the monitoring error correction unit 4; the monitoring error correction unit 4 using a hybrid attention neural network algorithm to correct the error of the temperature data to obtain the corrected temperature change rate; the thermal conductivity calculation unit 5 calculating the thermal conductivity of the medium at each position along the length direction of the pile foundation through the corrected temperature change rate.

(4) The scour area detection unit 6 calculating the thermal conductivity gradient along the length direction of the pile foundation according to the thermal conductivity of the medium, and determining the length of the scour area and the instability coefficient according to the results to confirm the scour state.

In step (1), the internal heating temperature-measuring optical cable 1 is fixed on the offshore wind turbine pile foundation with waterproof quick-drying adhesive; secondly, high-strength epoxy resin is used to protect the optical cable.

In step (1), to ensure data quality, a section of internal heating temperature-measuring optical cable is reserved at the bottom of the pile foundation; after the internal heating resistance wires 1-1 are welded, waterproof protection is performed.

In step (2), the heating time and heating power of the heating unit 2 are set according to the designed buried depth of the pile foundation and the average local seawater depth.

In step (2), the sampling resolution S and collection frequency of the optical fiber temperature measurement unit 3 are determined according to the total length of the pile foundation.

In step (3), during the monitoring error correction process, to improve the calculation accuracy of the temperature change rate, data based on laboratory calibration is used to train the hybrid attention neural network.

(3.1) measuring and calculating a temperature change rate K_{T}_{ᵢ} of medium i between the heating times t₁ and t₂ by the optical fiber temperature measurement unit:

$${K}_{{T}_{i}} = \frac{{T}_{i} ( {t}_{2} ) - {T}_{i} ( {t}_{1} )}{{t}_{2} - {t}_{1}} ;$$

wherein the medium i comprises seawater, seabed sediments, and an interface between seawater and seabed sediments; T is temperature corresponding to two time points; Tᵢ(t₁) is a temperature corresponding to a line source in medium i measured by the optical fiber temperature measurement unit 3 at time t₁; T₁(t₂) is a temperature corresponding to the line source in medium i measured by the optical fiber temperature measurement unit 3 at time t₂;

measuring an accurate value K_{T}_{ᵢ} of the temperature change rate of the medium i within a same heating time period in a laboratory:

$${K}_{{T}_{i}}^{′} = \frac{{T}_{i}^{′} ( {t}_{2} ) - {T}_{i}^{′} ( {t}_{1} )}{{t}_{2} - {t}_{1}} ;$$

taking K_{T}_{ᵢ} as a target value for supervising a neural network; T₁′(t₁) is the temperature corresponding to the line source in the medium 1 measured in the laboratory at time t₁; T₁′(t₂) is the temperature corresponding to the line source in the medium i measured in the laboratory at time t₂;

obtaining a corrected temperature change rate K by using a following error correction formula:

$$K = {K}_{{T}_{i}} + Δ {K}_{{T}_{i}} ;$$

wherein K_{T}_{ᵢ} is a temperature change rate error correction value predicted by the hybrid attention neural network;

the obtaining the temperature change rate error correction value by using the hybrid attention neural network algorithm is as follows: taking temperature change rates K_{T}_{ᵢ} of various medium and temperature change rates along a monitoring optical fiber as an input temperature change rate feature matrix X of a hybrid attention neural network, and extracting the temperature change rate feature map F_{c} of input features through a lightweight one-dimensional convolution layer:

$${F}_{c} = σ ( W * X + b ) ;$$

wherein W is a convolution kernel weight, b is a bias term, σ is an activation function, and X is the input temperature change rate feature matrix of the hybrid attention neural network;

(3.2) performing channel-wise max pooling and average pooling operations on the temperature change rate feature map F_{c} to obtain a max pooling result Fₘₐₓ and an average pooling result F_{avg}:

$$\begin{matrix}{F}_{max} = max {F}_{c} ( X , c ) \\ {F}_{avg} = \frac{1}{C} {\sum }_{c = 1}^{C} {F}_{c} ( X , c )\end{matrix} ;$$

wherein c is a channel index, F_{c}(X,c) represents a feature value on the channel c after the input temperature change rate feature matrix X is processed by convolution and activation function; C is a total number of channels;

calculating a weight matrix A. of the temperature change rate feature map F_{c}:

$${A}_{c} = σ ( F C ( G A P ( {F}_{c} ) ) ) ;$$

wherein a Global Average Pooling (GAP) refers to calculating an average value of each channel of Fc to generate a feature vector of a specific length; a Fully Connected Layer (FC) refers to performing weighted learning on a feature vector to generate a weight of each channel;

adjusting each channel to obtain an enhanced temperature change rate feature map Fₑ:

$${F}_{e} = {A}_{c} ▯ {F}_{c} ;$$

wherein □ represents channel-wise dot multiplication;

(3.3) capturing a correlation between different positions of the enhanced temperature change rate feature map Fₑ by using a spatial attention mechanism, which is as follows:

first, generating a spatial weight Aₛ through multi-scale convolution:

$${A}_{s} = σ ( C o n v 2 D ( C o n c a t ( {F}_{max} , {F}_{a v g} ) ) ) ;$$

wherein Concat refers to concatenating Fₘₐₓ and F_{avg} in a channel dimension to generate a joint temperature change rate feature map; Conv2D refers to learning a spatial attention weight from a concatenated joint temperature change rate feature map through two-dimensional convolution to extract significant features and global distribution features;

then, optimizing an enhanced temperature change rate feature map to obtain F_{final}:

$${F}_{final} = {A}_{s} ▯ {F}_{e} ;$$

finally, correcting the optimized temperature change rate feature map F_{final} through quadratic weighted integration to obtain a temperature change rate error correction value K_{T}_{ᵢ} of the medium i within the heating time:

$$Δ {K}_{{T}_{i}} = \int {}_{Ω} {F}_{f i n a l} ▯ {W}_{c o r r} d Ω ;$$

wherein Wcorr is a correction weight matrix, and Ω is a calculation area. A loss function L is used to optimize the correction weight matrix Wcorr and the temperature change rate error correction value K_{T}_{ᵢ} of the hybrid attention neural network; the loss function is:

$$L = \sum {w}_{i} ( ( {K}_{{T}_{i}} + Δ {K}_{{T}_{i}} ) - {K}_{{T}_{i}}^{′} ) + λ {‖ {W}_{c o r r} ‖}^{2} ;$$

wherein wᵢ is a weight for the medium i, λ is a parameter of regularization strength, Wcorr is the correction weight matrix, and λ∥W_{corr}∥² is a regularization term; the loss function L updates the correction weight matrix Wcorr in each iteration, and outputs the corrected temperature change rate K when the loss function L reaches a minimum value.

In step (3), the thermal conductivity λₗ of the medium at a length l of the pile foundation is obtained by a formula:

$${λ}_{l} = \frac{q}{4 π K} ;$$

wherein λₗ is the thermal conductivity at the length l of the pile foundation, in unit W/(m·K), q is a heating power of the linear heat source, in unit W/m; K is a temperature change rate at the length l of the pile foundation corrected by the hybrid attention neural network, in unit K.

In step (4), the process by which the scour area detection unit 6 detects the scour area based on the thermal conductivity gradient of the medium is as follows:

The present application adopts the linear heat source heating method to measure the thermal conductivity along the length direction of the offshore wind turbine pile foundation. Different types of medium have different thermal conductivities due to their different heat absorption capacities. Therefore, the derivative of the thermal conductivity along the entire length direction of the pile foundation is calculated to obtain the thermal conductivity change rate, namely the thermal conductivity gradient. At the position where the thermal conductivity changes (i. e., the interface between the seabed and seawater), the thermal conductivity gradient will abruptly change. Thus, the thermal conductivity gradient curve obtained immediately after the pile foundation is installed is used as the reference. The scour area detection unit 6 compares the thermal conductivity gradient curve obtained during the monitoring process with the reference curve, and determines the range of the scour area according to the position difference of the abrupt change points between the two curves.

In step (4), the scour area detection unit 6 uses the thermal conductivity obtained in step (3) to calculate a thermal conductivity gradient gₗ, the formula is follow:

$${g}_{l} = \frac{{λ}_{l} - {λ}_{x}}{X} ;$$

wherein λₗ is the thermal conductivity at the length l; λₓ is a thermal conductivity at an adjacent length x to the length l; X is a distance between two measuring points, and X is L/S, Lis a total length of a monitoring section, and S is a sampling resolution.

In step (4), the scour area detection unit 6 detects a position difference of the thermal conductivity gradient mutation points between a thermal conductivity gradient curve and a reference curve, to obtain a length d of the scour area, a formula is: d=L₂−L₁;

wherein L₂ is a position of a mutation point in the thermal conductivity gradient curve; L₁ is a position of the mutation point in a reference curve;

wherein the length d of the scour area is compared with an original buried depth D of the foundation to obtain an instability coefficient F:

$$F = \frac{d}{D} ;$$

when the instability coefficient F is greater than a safety threshold f, a scour state of the pile foundation is unstable, there is a risk of collapse of the superstructure; when the instability coefficient F is less than the safety threshold f, the scour state of the pile foundation is stable, the superstructure is safe.

### EMBODIMENT

The dynamic monitoring device and method for the scour interfaces of offshore wind turbine pile foundations of the present application are used to monitor the scour condition of a certain offshore wind turbine pile foundation. The offshore wind turbine has a capacity of 6 MW, adopts a monopile foundation, the pile is made of steel material, the diameter of the pile foundation is 5 m, the total length of the pile foundation is 50 m, the buried depth of the foundation is 25 m, the average water depth of the detection site is 20 m, and the type of marine sediment is fine sand with a particle size range of 0.063 mm-0.1 mm.

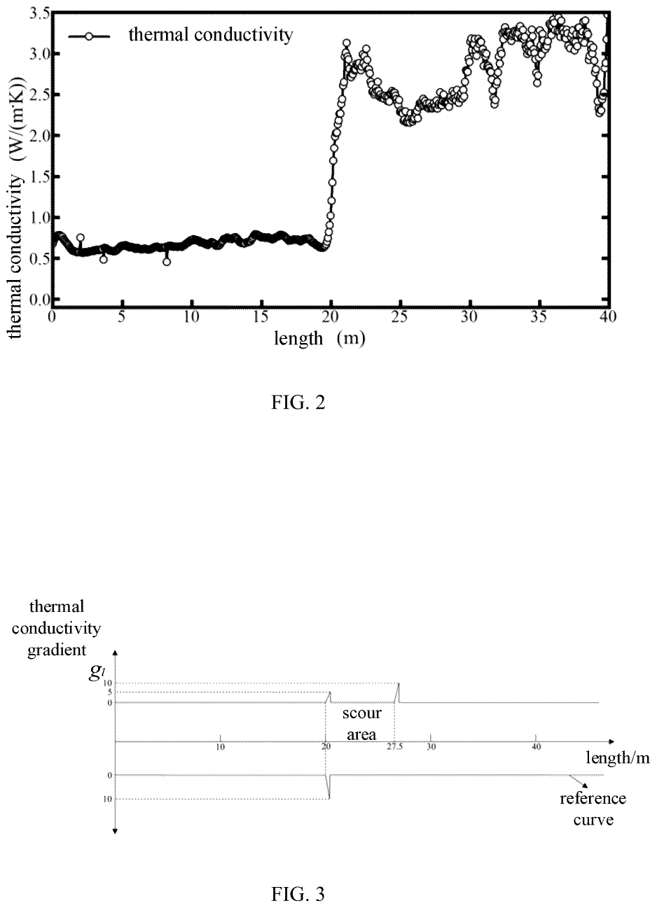

The dynamic monitoring method for the scour interfaces of offshore wind turbine pile foundations of the present application includes:
(1) After the fabrication of the pile foundation is completed, symmetrically pasting two 50 m-long internal heating temperature-measuring optical cables 1 on both sides of the pile foundation with waterproof quick-drying adhesive;
(2) Stripping the tail ends of the internal heating temperature-measuring optical cables 1, welding the two internal heating resistance wires 1-1 together by electric welding, and tightly wrapping them with waterproof insulating tape;
(3) After the construction of the pile foundation is completed, connecting the internal heating resistance wires 1-1 in the internal heating temperature-measuring optical cables at the top of the pile foundation to the heating unit 2, and connecting the temperature-sensing optical fibers 1-2 in the internal heating temperature-measuring optical cables 1 to the optical fiber temperature measurement unit 3 through optical fiber jumpers;
(4) Adjusting the heating power q of the heating unit 2 to 80 W, setting the heating time to 1 minute, then powering on, the optical fiber temperature measurement unit 3 collecting the temperature data during the heating period with a resolution of 1 cm and a collection frequency of 10 Hz, and using this data as a reference;
(5) After the pile foundation is put into use, regularly monitoring the local scour state of the pile foundation every day, adjusting the heating power of the heating unit 2 to 80 W, setting the heating time to 1 minute, then powering on, the optical fiber temperature measurement unit 3 collecting the temperature data during the heating period with a resolution of 1 cm;
(6) Transmitting the temperature data collected by the optical fiber temperature measurement unit 3 to the monitoring error correction unit 4, the monitoring error correction unit 4 using a hybrid attention neural network algorithm to correct the error of the monitoring data to obtain the corrected temperature change rate K at each position;
(7) The monitoring error correction unit 4 transmitting the corrected temperature data to the thermal conductivity calculation unit 5, the thermal conductivity calculation unit 5 calculating the thermal conductivity of the medium at the length l of the pile foundation according to the following formula (the result is shown in FIG. 2):

$${λ}_{l} = \frac{q}{4 π K} ;$$

wherein λₗ is the thermal conductivity at the length l of the pile foundation, in unit W/(m·K), q is a heating power of the linear heat source, in unit W/m; K is a temperature change rate at the length l of the pile foundation corrected by the hybrid attention neural network, in unit K;

(8) The scour area detection unit 6 calculating the thermal conductivity gradient according to the following formula (the result is shown in FIG. 3):

$${g}_{l} = \frac{{λ}_{l} - {λ}_{x}}{X} ;$$

Wherein λₗ is the thermal conductivity at the length l; λₓ is a thermal conductivity at an adjacent length x to the length l; X is a distance between two measuring points, and X is L/S, Lis a total length of a monitoring section, and S is a sampling resolution.

The results show that after the pile foundation has been used for one year, the foundation scour depth d is 7.5 m, and the instability coefficient F is 0.3, which is close to the instability coefficient of 0.4 specified in the standard, so scour prevention measures need to be taken.

What is claimed is:

1. A dynamic monitoring method for scour interfaces of offshore wind turbine pile foundations, implemented by a dynamic monitoring device for the scour interfaces of offshore wind turbine pile foundations;
wherein the monitoring device comprises an internal heating temperature-measuring optical cable, a heating unit, an optical fiber temperature measurement unit, a monitoring error correction unit, a thermal conductivity calculation unit and a scour area detection unit;
wherein the internal heating temperature-measuring optical cable comprises an internal heating resistance wire and a temperature-sensing optical fiber; the internal heating temperature-measuring optical cable is fixed on the offshore wind turbine pile foundation; the internal heating resistance wire is connected to the heating unit, and the temperature-sensing optical fiber is connected to the optical fiber temperature measurement unit;
after collecting temperature data of the internal heating temperature-measuring optical cable during a heating process, the optical fiber temperature measurement unit is configured to transmit the temperature data to the monitoring error correction unit;
the method comprises:
(1) fixing the internal heating temperature-measuring optical cable on the offshore wind turbine pile foundation, connecting the internal heating resistance wire to the heating unit, and connecting the temperature-sensing optical fiber to the optical fiber temperature measurement unit;
(2) powering on the heating unit, and the optical fiber temperature measurement unit collecting the temperature data of the temperature-measuring optical cable during the heating process;
(3) the optical fiber temperature measurement unit transmitting the temperature data to the monitoring error correction unit; the monitoring error correction unit using a hybrid attention neural network algorithm to correct an error of the temperature data, and transmitting a corrected temperature change rate to the thermal conductivity calculation unit; the thermal conductivity calculation unit calculating a thermal conductivity along a length direction of the pile foundation according to the corrected temperature change rate, comprising:
(3.1) measuring and calculating a temperature change rate K_{T}_{ᵢ} of medium i between the heating times t₁ and t₂ by the optical fiber temperature measurement unit:
$${K}_{{T}_{i}} = \frac{{T}_{i} ( {t}_{2} ) - {T}_{1} ( {t}_{1} )}{{t}_{2} - {t}_{1}} ;$$
wherein the medium i comprises seawater, seabed sediments, and an interface between seawater and seabed sediments; Tᵢ(t₁) is a temperature corresponding to a line source in medium measured by the optical fiber temperature measurement unit at time t₁; T₁(t₂) is a temperature corresponding to a line source in medium i measured by the optical fiber temperature measurement unit at time t₂;
measuring an accurate value K_{T}_{ᵢ} of the temperature change rate of the medium i within a same heating time period in a laboratory:
$${K}_{{T}_{i}}^{′} = \frac{{T}_{i}^{′} ( {t}_{2} ) - {T}_{i}^{′} ( {t}_{1} )}{{t}_{2} - {t}_{1}} ;$$
taking K_{T}_{ᵢ} as a target value for supervising a neural network; T₁′(t₁) is the temperature corresponding to the line source in the medium i measured in the laboratory at time t₁; t₁′(t₂) is the temperature corresponding to the line source in the medium i measured in the laboratory at time t₂;
obtaining a corrected temperature change rate K by using a following error correction formula:
$$K = {K}_{{T}_{i}} + Δ {K}_{{T}_{i}} ;$$
wherein K_{T}_{ᵢ} is a temperature change rate error correction value predicted by the hybrid attention neural network;
a process of calculating the temperature change rate error correction value K_{T}_{ᵢ} is as follows:
taking temperature change rates K_{T}_{ᵢ} of various medium and temperature change rates along a monitoring optical fiber as an input temperature change rate feature matrix X of a hybrid attention neural network, and extracting a temperature change rate feature map F_{c} of input features:
$${F}_{c} = σ ( W * X + b ) ;$$
wherein W is a convolution kernel weight, b is a bias term, σ is an activation function, and X is the input temperature change rate feature matrix of the hybrid attention neural network;
(3.2) performing channel-wise max pooling and average pooling operations on the temperature change rate feature map F_{c} to obtain a max pooling result Fₘₐₓ and an average pooling result F_{avg}:
$${F}_{max} = max {F}_{c} ( X , c )$$
$${F}_{avg} = \frac{1}{C} {\sum }_{c = 1}^{C} {F}_{c} ( X , c ) ;$$
wherein c is a channel index, F_{c}(X,c) represents a feature value on the channel c after the input temperature change rate feature matrix X is processed by convolution and activation function; C is a total number of channels;
calculating a weight matrix A_{c} of the temperature change rate feature map F_{c}:
$${A}_{c} = σ ( FC ( GAP ( {F}_{c} ) ) ) ;$$
wherein a Global Average Pooling (GAP) refers to calculating an average value of each channel of F_{c} to generate a feature vector of a specific length; a Fully Connected Layer (F_{c}) refers to performing weighted learning on a feature vector to generate a weight of each channel;
adjusting each channel to obtain an enhanced temperature change rate feature map Fₑ:
$${F}_{e} = {A}_{c} {F}_{c} ;$$
wherein □ represents channel-wise dot multiplication;
(3.3) capturing a correlation between different positions of the enhanced temperature change rate feature map Fₑ by using a spatial attention mechanism, which is as follows:
generating a spatial weight Aₛ through multi-scale convolution:
$${A}_{s} = σ ( Conv 2 D ( Concat ( {F}_{max} , {F}_{avg} ) ) ) ;$$
wherein Concat refers to concatenating Fₘₐₓ and F_{avg} in a channel dimension to generate a joint temperature change rate feature map; Conv2D refers to learning a spatial attention weight from a concatenated joint temperature change rate feature map through two-dimensional convolution to extract significant features and global distribution features;
optimizing an enhanced temperature change rate feature map to obtain F_{final}:
$${F}_{final} = {A}_{s} {F}_{e} ;$$
correcting the optimized temperature change rate feature map F_{final} to obtain a temperature change rate error correction value K_{T}_{ᵢ} of the medium i within the heating time:
$$Δ {K}_{{T}_{i}} = {\int }_{Ω} {F}_{final} {W}_{corr} d Ω ;$$
wherein W_{corr} is a correction weight matrix, and Ω is a calculation area;
wherein the thermal conductivity calculation unit calculates the thermal conductivity λₗ of the medium at a length l of the pile foundation according to the corrected temperature change rate:
$${λ}_{l} = \frac{q}{4 π K} ;$$
wherein q is a heating power of the linear heat source, in unit W/m; K is a temperature change rate at the length l of the pile foundation corrected by the hybrid attention neural network, in unit K;
(4) wherein the scour area detection unit calculates a thermal conductivity gradient gₗ along a length direction of the pile foundation according to a thermal conductivity of the medium:
$${g}_{l} = \frac{{λ}_{l} - {λ}_{x}}{X} ;$$
wherein λₗ is the thermal conductivity at the length l; λₓ is a thermal conductivity at an adjacent length x to the length l; X is a distance between two measuring points, and X is L/S, L is a total length of a monitoring section, and S is a sampling resolution;
wherein the scour area detection unit detects a position difference of the thermal conductivity gradient mutation points between a thermal conductivity gradient curve and a reference curve when the pile foundation installation is completed, to obtain a length d of the scour area: d=L₂−L₁;
wherein L₂ is a position of a mutation point in the thermal conductivity gradient curve; L, is a position of the mutation point in a reference curve;
wherein the length d of the scour area is compared with an original buried depth D of the foundation to obtain an instability coefficient F:
$$F = \frac{d}{D} ;$$
when the instability coefficient F is greater than a safety threshold f, a scour state of the pile foundation is unstable; when the instability coefficient F is less than the safety threshold f, the scour state of the pile foundation is stable.

2. The dynamic monitoring method for scour interfaces of offshore wind turbine pile foundations according to claim 1, wherein in step (3.1), the temperature change rate feature map F_{c} of the input features is extracted by a lightweight one-dimensional convolution layer:
$${F}_{c} = σ ( W * X + b ) ;$$
wherein W is a weight of the one-dimensional convolution kernel, b is a bias term, σ is an activation function, and X is the input temperature change rate feature matrix of the neural network.

3. The dynamic monitoring method for scour interfaces of offshore wind turbine pile foundations according to claim 1, wherein in step (3.2), a weight matrix A_{c} of the temperature change rate feature map F_{c} is calculated based on a channel attention mechanism of global pooling:
$${A}_{c} = σ ( FC ( GAP ( {F}_{c} ) ) ) ;$$
wherein GAP refers to calculating the average value of each channel of F_{c} to generate a feature vector of a specific length; FC refers to performing weighted learning on the feature vector to generate the weight of each channel.

4. The dynamic monitoring method for scour interfaces of offshore wind turbine pile foundations according to claim 1, wherein in step (3.3), the optimized temperature change rate feature map F_{final} is corrected by quadratic weighted integration to obtain the temperature change rate error correction value K_{T}_{ᵢ} of the medium i within the heating time.

5. The dynamic monitoring method for scour interfaces of offshore wind turbine pile foundations according to claim 1, wherein in step (3.3), a loss function L is used to optimize the correction weight matrix W_{corr} and the temperature change rate error correction value K_{T}_{ᵢ} of the hybrid attention neural network; the loss function is:
$$L = \sum {w}_{i} ( ( {K}_{{T}_{i}} + Δ {K}_{{T}_{i}} ) - {K}_{{T}_{i}}^{′} ) + λ {‖ {W}_{corr} ‖}^{2} ;$$
wherein wᵢ is a weight for the medium i, λ is a parameter of regularization strength, W_{corr} is the correction weight matrix, and λ∥W_{corr}∥² is a regularization term; the loss function L updates the correction weight matrix W_{corr} in each iteration, and outputs the corrected temperature change rate K when the loss function L reaches a minimum value.

6. The dynamic monitoring method for scour interfaces of offshore wind turbine pile foundations according to claim 1, wherein in step (1), the internal heating temperature-measuring optical cable is fixed on the offshore wind turbine pile foundation by using waterproof adhesive.

7. The dynamic monitoring method for scour interfaces of offshore wind turbine pile foundations according to claim 1, wherein in step (1), the internal heating temperature-measuring optical cable is protected by epoxy resin after being fixed.

8. The dynamic monitoring method for scour interfaces of offshore wind turbine pile foundations according to claim 1, wherein in step (1), the internal heating temperature-measuring optical cable is reserved at a bottom of the pile foundation.

9. The dynamic monitoring method for scour interfaces of offshore wind turbine pile foundations according to claim 1, wherein in step (2), heating time and heating power of the heating unit are determined according to a designed buried depth of the pile foundation and an average depth of seawater.
